(19) United States
(12) Patent Application Publication
(10) Pub. No.: US 2004/0258244 A1
(43) Pub. Date: Dec. 23, 2004

(54) Video encryption

(76) Inventors: Nadeemul Haq, San Jose, CA (US); Abulgasem Hassan Aboulgasem, Santa Clara, CA (US)

Correspondence Address: DAVID GIGLIO, Attorney at law, 231 Elizabeth St., Utica, NY, 13501, US

(21) Appl. No.: 10/872,842

(22) Filed: Jun. 21, 2004

Related U.S. Application Data
(60) Provisional application No. 60/481,006, filed on Jun. 21, 2003.

(51) Int. Cl. H04N 7/167

(52) U.S. Cl. 380/210

(57) ABSTRACT

The present invention provides a method of minimizing the computation requirements involved in transmitting video images. By encrypting only a select portion of the transmitted data the transmission rate is improved without compromising privacy and still thereby reducing the compute time requirements. Wavelet-transform is repeatedly applied to a pixel matrix until a smooth coefficient matrix is achieved. The smooth coefficient matrix is necessary to regenerate the transmitted image at the receiving end. Only a single value of the smooth coefficient matrix is encrypted, thereby increasing the transmission rate of the entire image.

A portion of the disclosure of this patent document contains material to which the claim of copyright protection is made. The copyright owner has no objection to the facsimile reproduction by any person of the patent document or the patent disclosure, as it appears in the U.S. Patent and Trademark Office patent file or records, but reserves all other rights whatsoever. This patent application claims priority from provisional patent application 60/481,006 filed on Jun. 21, 2003 by the same inventors which is incorporated herein by reference.

### FIELD OF THE INVENTION

This invention relates generally to the field of transmitting and receiving video data encryption and, more particularly, to a method of encrypting video data for improved transmission.

### BACKGROUND OF THE PRESENT INVENTION

One requirement of communication over insecure networks is the provisioning of end-to-end encryption for privacy. Many encryption algorithms are known that can successfully be utilized to provide privacy. Multi-media communication however implies large amounts of video data encryption, which adds to the compute cost and potentially impacts the quality of communication.

Multi-media communication systems exploits temporal and spatial redundancy in natural video frame sequences to achieve high degree of compression and consequently optimal use of transmission bandwidth. A transmitted video sequence is encoded as a series of packetized reference frames interspersed with motion vectors and associated error packets at the source. The receiver uses the intra-coded images (I-frames) as reference frames and generates two types of dependent frames: predictive coded frames (P-frames) and bi-directionally coded frames (B-frames).

P frames are coded predictively from the closest previous I-frame; B-frames are coded bi-directionally from the preceding and succeeding I-frame and/or P-frame. Generation of P-frames and B-frames is therefore entirely dependent on I-frames.

Typical compression algorithms employ a mathematical transform on all or part of the captured image. The result of the transform is quantized and encoded to achieve spatial compression. One such well-known transform is the wavelet transform.

Successive application of the wavelet transform in two dimensions decomposes the two dimensional image matrix into hierarchical sub-bands of coefficients. However, it is tedious and cumbersome to encrypt an entire video image.

### SUMMARY OF THE PRESENT INVENTION

It is an object of the present invention to improve the are of video transmission.

It is yet another object of the present invention to improve video encryption techniques.

These and other objects of the present invention are achieved by a method of compressing said pixel matrix using wavelet-transform, creating a “mother-function coefficients sub-band” responsive to said compression step, and encrypting a single value of each group of tree-roots that comprise the “mother-function coefficients sub-band.”

### BRIEF DESCRIPTION OF THE DRAWINGS

No drawings are necessary for an understanding of the present invention.

### DESCRIPTION OF INVENTION

When applying wavelet transform for compression, decomposition of the image matrix is achieved by successive applications of a wavelet transform. The wavelet transform is applied to each row of the image of dimension N, first over vector of length N then over the “smooth” vector of length N/2, then over the “smooth-smooth” vector of length N/4 and so on, until only a trivial number of “smooth- . . . -smooth” components (usually 2) remain for each row.

The smooth vector in each instance is obtained by critically sub-sampling the result of application of the transform.

The process is repeated for each column of the image of dimension M until only a trivial number of “smooth- . . . -smooth” (usually 2) components remain for each column.

The final result is a matrix of coefficients of dimensions N×M.

The matrix comprises of a hierarchy of sub-bands. The sub-bands are logarithmically spaced in frequency and represent octave-band decomposition.

The lowest frequency sub-band is a representation of the information at all coarser scales. This sub-band comprises of the “smooth- . . . -smooth” coefficients also known as the “mother-function coefficients” which were obtained in the last iteration of transformation.

The invention proposes to encrypt in a loss-less way one coefficient, the coefficient that does not have any descendents, from each group of roots that comprise the “mother-function coefficient sub-band.” This suffices to encrypt the whole image since inverse transformation to retrieve the original image (the I-frame) requires the “mother-function coefficients” for regeneration Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

We claim:

1. A method for encrypting video data, wherein said video data includes a pixel matrix, motion vectors and associated prediction errors, said method comprising:
compressing said pixel matrix using wavelet-transform;
creating a smooth coefficient matrix responsive to said compression step; and
encrypting a single value of said smooth coefficient matrix.

2. The method of claim 1, wherein the step of encrypting a single value of said smooth coefficient matrix further includes the step of encrypting the first coefficient of said smooth coefficient matrix, wherein said coefficient matrix is a two by two matrix.
